(19) United States
(12) Patent Application Publication
(10) Pub. No.: US 2007/0097720 A1
(43) Pub. Date: May 3, 2007

(54) Lus semiconductor and synchronous rectifier circuits

(76) Inventor: Chao-Cheng Lu, Taipei (TW)

Correspondence Address: CHAO-CHENG LU, 4-4, Alley 27, Lane 143, Chun Kung Road, Taipei, 11614, TW

(21) Appl. No.: 11/263,243

(22) Filed: Nov. 1, 2005

(51) Int. Cl. H02M 7/217

(52) U.S. Cl. 363/127

(57) ABSTRACT

The Lus Semiconductor in this invention is characterized by replacing the static shielding diode (SSD) of traditional Power Metal Oxide Semiconductor Field Effect Transistors (Power MOSFETs) with polarity reversed (comparing with traditional SSD) SSD, Schottky Diode, or Zener Diode, or face-to-face or back-to-back coupled Schottky Diodes, Zener Diodes, Fast Diodes, or Four Layer Devices such as DIAC and Triac. With the proposed Power MOSFETs of which the drain to source resistors (Rds) are quite low, two major functions of high efficiency synchronous rectification may be achieved.

### BACKGROUND OF THE INVENTION

1. Field of the Invention

This invention is related to Power Metal Oxide Semiconductor Field Effect Transistors, Power MOSFETs for synchronous rectifier circuits, especially Power MOSFETs with novel structures replacing conventional Static Shielding Diodes, SSDs. According to this invention, traditional SSDs in Power MOSFETs may be replaced with polarity reversed (comparing with traditional SSD) SSDs, Schottky Diodes, or Zener Diodes, or face-to-face/back-to-back coupled Schottky Diodes, Zener Diodes, Fast Diodes, or Four Layer Devices such as DIACs and TRIACs or snubber circuits such that conventional functions are preserved and need only to consider the amplitude of the reverse biased voltage for proper semiconductor operating voltage. As shown in FIG. 2 (E) or (F), the amplitude of the reverse biased operating voltage, i.e. Zener Voltage, may be configured according to the needs. The set Zener voltage would be higher than the DC output voltage in actual applications according to this invention. That is, the voltage of conventional SSD in Power MOSFETs is higher than the AC voltage at input side, but the Zener voltage of the polarity reversed coupling Zener Diode is higher than the DC output voltage. According to such design philosophy of this invention, half-wave synchronous rectification may be achieved with a single Power MOSFET in coordination with auxiliary circuits, and full-wave synchronous rectification may be achieved with two Power MOSFETs in coordination with auxiliary circuits. Hence, functions of high efficiency synchronous rectification may be achieved.

2. Description of the Related Art

FIG. 3 shows a circuit of a conventional single ended forward synchronous rectifier. In this figure, MOSFET V1 is responsible for rectification while MOSFET V2 is responsible for freewheeling. In operation, when the secondary voltage Us is at the positive half cycle, MOSFET V1 closes and MOSFET V2 opens, and MOSFET V1 acts as a rectifier; when the secondary voltage Us is at the negative half cycle, MOSFET V1 opens and MOSFET V2 closes, and MOSFET V1 acts as a free-wheel. The conductive power waste of MOSFET V1 and MOSFET V2, and the driving power waste of the gates produce the main power waste in the synchronous rectifier circuit. Such scheme comes with the following drawbacks:

1. As far as the power waste is concerned, the power lost due to the follow current results in lower efficiency of synchronous rectification.

2. As far as the cost of material is concerned, Power MOSFETs used for synchronous rectification raises the cost of manufacture.

### SUMMARY OF THE INVENTION

In order to provide semiconductor devices that may elevate the efficiency of rectification and provide function of voltage regulation, this invention is proposed according to the following objects.

The first object of this invention is to provide semiconductor devices that eliminate the drawback of high power consumption of conventional synchronous rectifiers utilizing diodes, such as Schottky diodes.

The second object of this invention is to decrease the cost of manufacture due to Power MOSFETs used for synchronous rectification.

The third object of this invention is to eliminate the drawback that only certain groups of output voltage can be regulated while other plurality of output may not be able to be regulated in the conventional PWM or PFM switching power systems.

In order to solve the problem of high power consumption in conventional rectifiers and voltage regulation systems, the present invention possesses the following characteristics:

1. Unlike the manufacture process of conventional power MOSFETs, the polarity of single parasitic diode, SSD, is reversed, or the conventional SSD is replaced with two of face-to-face/back-to-back coupled diodes, i.e., in the manufacture process of power MOSFETs, coupling characteristic structures of the Lus Semiconductors between drain node and source node as shown in FIG. 2.

2. If no parasitic diodes exist in conventional power MOSFETs, the characteristic structures shown in FIG. 2, their permutations and combinations, and even snubber circuits may also be externally coupled between the drain nodes and source nodes to construct the Lus Semiconductors.

3. The Lus Semiconductors in the present invention may also be applied in conventional PWM and PFM power systems. Rectifier diodes may be replaced with Lus Semiconductors and the efficiency may be improved.

According to the defects of the conventional technology discussed above, a novel solution, the Lus Semiconductor, is proposed in the present invention, which provides higher efficiency in synchronous rectification.

### BRIEF DESCRIPTION OF THE DRAWINGS

FIG. 1 shows the structures of an N-Channel Power MOSFET and a P-Channel Power MOSFET of the Lus Semiconductor according to the present invention.

FIG. 2 shows characteristic circuit structures of the Lus Semiconductor coupled between the drain and source of the power MOSFETs shown in FIG. 1.

FIG. 3 shows a circuit of a conventional single ended forward synchronous rectifier.

FIG. 4 shows the symbols for N-Channel and P-channel Lus Semiconductors.

FIG. 5 shows one embodiment of full-wave synchronous rectifier and voltage regulation circuit according to the present invention.

FIG. 6 shows one embodiment of half-wave synchronous rectifier and voltage regulation circuit according to the present invention.

### DETAILED DESCRIPTION OF THE INVENTION

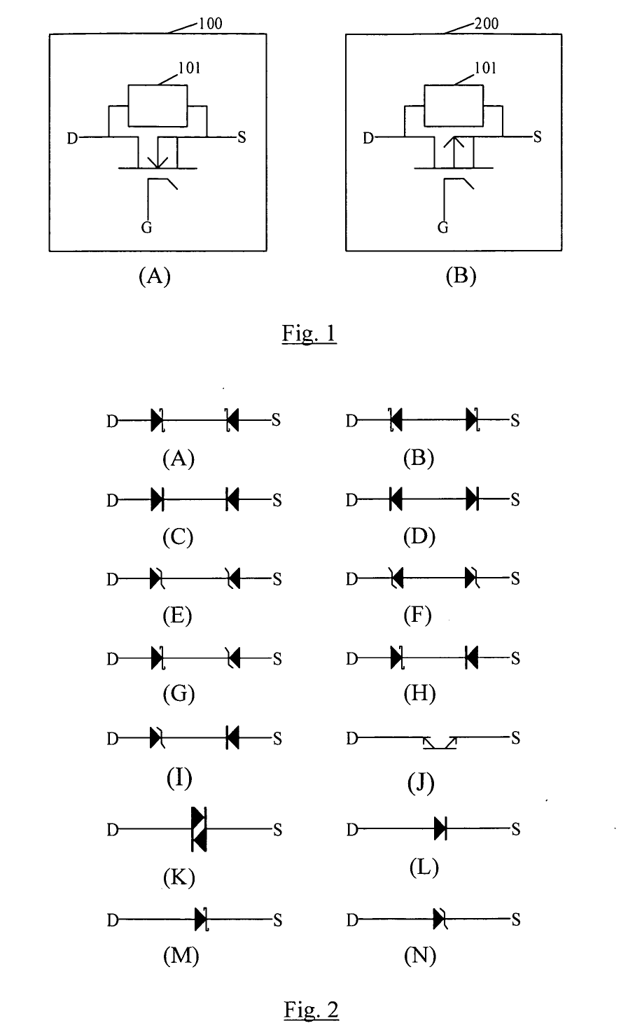

FIG. 1 shows the structures of an N-Channel power MOSFET 100 and a P-Channel power MOSFET 200 of Lus Semiconductor according to the present invention. FIG. 2 shows several characteristic circuit structures 101 of Lus Semiconductor that may be coupled between the drain nodes and the source nodes of power MOSFETs shown in FIG. 1. A pair of face-to-face coupled Schottky diodes and a pair of back-to-back coupled Schottky diodes are shown in FIG. 2 (A) and FIG. 2 (B) respectively, and each of the two may be then coupled to the drain node and the source node of the power MOSFETs. A pair of face-to-face coupled SSDs and a pair of back-to-back coupled SSDs is shown in FIG. 2 (C) and FIG. 2 (D) respectively, and each of the two may be then coupled to the drain node and source node of the power MOSFETs. A pair of face-to-face coupled Zener diodes and pair of back-to-back coupled Zener diodes is shown in FIG. 2 (E) and FIG. 2 (F) respectively, and each of the two may be then coupled to the drain node and source node of the power MOSFETs. FIG. 2 (G) shows a pair of face-to-face coupled Schottky diode and Zener diode, which may then be coupled to the drain node and the source node of the power MOSFETs. FIG. 2 (H) shows a pair of face-to-face coupled Schottky diode and SSD, which may then be coupled to the drain node and the source node of the power MOSFETs. FIG. 2 (I) shows a pair of face-to-face coupled Zener diode and fast diode, which may then be coupled to the drain node and the source node of the power MOSFETs. FIG. 2 (J) shows a DIAC four layer semiconductor and FIG. 2 (K) shows a TRIAC four layer semiconductor, each of the two may then be coupled to the drain node and the source node of the power MOSFETs. The characteristic circuit structures 101 shown in FIG. 2 (A)˜(K), their permutations and combinations and snubber circuits may all be coupled to the drain node and the source node of the power MOSFETs and Lus Semiconductors 100, 200 are thus constructed. With the characteristic circuit structures 101 shown in FIG. 2 (A)˜(K), their permutations and combinations and snubber circuits, high efficiency rectification and voltage regulation may be achieved, with a single power MOSFET. Comparing with the structures of a conventional N-Channel MOSFET or a conventional P-Channel MOSFET, one can tell that they are the totally different from the characteristic circuit structures of the Lus Semiconductors.

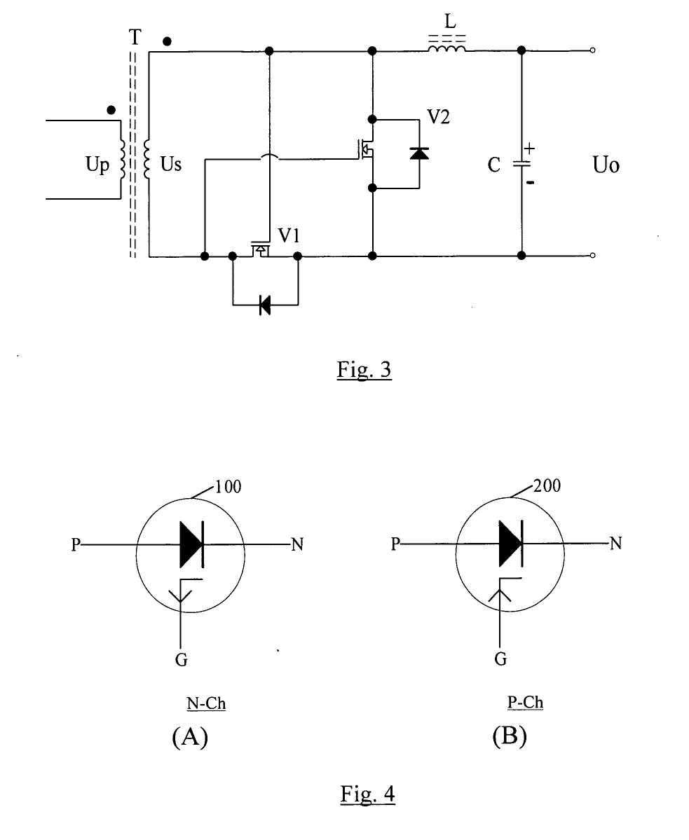

FIG. 3 shows a circuit of a conventional single ended forward synchronous rectifier. Its operations were described in the description of the related art and will not be discussed here for conciseness.

FIG. 4 shows the symbols for N-Channel and P-channel Lus Semiconductors wherein FIG. 4(A) is an N-Channel Lus Semiconductor and FIG. 4(B) is a P-Channel Lus Semiconductor wherein the P junction is the input pole, the N junction is the output pole and the G (Gate) is the control pole. The GN voltage may control the voltage drop between the P junction and the N junction such that the purpose of gate controlled voltage drop may be achieved.

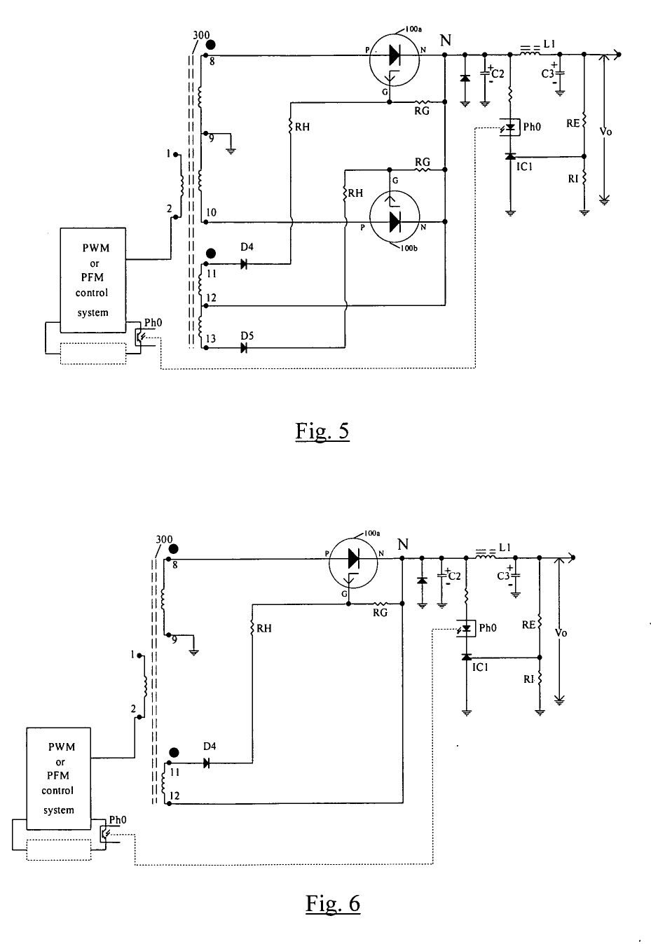

FIG. 5 shows one embodiment of full-wave synchronous rectifier and voltage regulation circuit according to the present invention. In operation, while the voltage at node 8 of the first secondary winding of the high frequency transformer 300 is at positive half cycle, the voltage at node 11 of the secondary winding is also at positive half cycle. The positive voltage at node 11 flows through diode D4 and voltage dividing resistors RG and RH. Thus the GN voltage of the Lus Semiconductor 100a equals to the voltage drop between the two ends of the voltage-dividing resistor RG. Because the RDS of the Power MOSFET of the Lus Semiconductor 100a is quite small, for example, RDS=5mΩ. If the current through RDS is 10 A, then the voltage drop between the two ends of RDS is VDS=0.005(Ω)×10(A)=0.05V. Let the saturation voltage of the diode of the characteristic circuit 101 be VF=0.7V, comparing VDS with VF, the diode of the characteristic circuit can be found open, thus the voltage drop between the two ends of the voltage dividing resistor RG conducts the drain and source of the Lus Semiconductors 100a. The positive half cycle AC voltage at node 8 passes through the drain and source of the Lus Semiconductor 100a and a π-type filter constructed with a filter capacitor C2, an inductor L1 and a filter capacitor C3, thus becomes DC output voltage Vo. While the AC voltage at the node 10 of the first secondary winding of the high frequency transformer 300 is at positive half cycle, the voltage at node 13 of the secondary winding is also at positive half cycle. The positive voltage at node 13 flows through diode D5 and voltage dividing resistors RG and RH. Thus the GN voltage of the Lus Semiconductor 100b equals to the voltage drop between the two ends of the voltage-dividing resistor RG. Because the RDS of the Power MOSFET of the Lus Semiconductor 100b is quite small, the voltage drop between the two ends of the voltage-dividing resistor RG conducts the drain and source of the Lus Semiconductors 100b. The middle node of the second secondary winding is at node 12 which is also coupling to node N, thus formed a complete gate controlled circuit. The operation is identical to that while the AC voltage at the node 8 of the first secondary winding of the high frequency transformer 300 is at positive half cycle. Because those two half-cycle circuits are commonly connected at node N, full-wave rectification may be achieved. While the output voltage Vo is higher than a pre-defined voltage, an adjustable precision shunt regulator integrated circuit IC1 may be activated, and meanwhile the collector and the emitter at the output side of a photo coupler Ph0 may be conducted that decreases the duty cycle of the output wave of the PWM control circuit and lower the output voltage Vo to the predetermined voltage; while the output voltage Vo drops, IC1 deactivates and increase the duty cycle of the output wave of the PWM control circuit and thus raise the output voltage Vo. According to the operation, the Lus Semiconductors 100a, 100b are capable of rectification. While the voltage at node 8 of the high frequency transformer 300 is set to be positive, let the reverse biased break down voltage of the diode of the characteristic circuit structure 101a of the Lus Semiconductor 100a is higher than the positive voltage at node 8, thus the voltage at node 8 may not pass through the reversed diode but through the drain and source of the Lus Semiconductor 100a. While the output voltage Vo is present, even though the voltage at node 8 is at the negative half cycle of the AC voltage, because the reverse biased break down voltage of the reverse coupled Schotty diode in the characteristic circuit structure lOla is higher than the output voltage Vo, the possibility that the first secondary winding may be burned out by the reverse current of conventional power MOSFETs can be eliminated. The operation of the characteristic circuit structure 101b in the Lus Semiconductor 100b at node 10 is identical. According to the operation of the characteristic circuit structure 101 in the present invention, the reverse biased break down voltage may be configured according to applications and shall not be limited. The operations of voltage regulation in PWM or PFM power systems are known to person skilled in the art and will not be discussed here for conciseness.

FIG. 6 shows one embodiment of half-wave synchronous rectifier and voltage regulation circuit according to the present invention. As shown in the figure, it removed the Lus Semiconductor 100b, node 10 of the first secondary winding and node 13 of the second secondary winding shown in FIG. 5 and thus became a half-wave synchronous rectifier and voltage regulation circuit. The operation of the circuit is identical to that of the Lus Semiconductor 100a shown in FIG. 5 and will not be discussed here for conciseness.

What is claimed is:

1. A power semiconductor device for synchronous rectification wherein at least one characteristic circuit being developed between a drain node and a source node of a metal oxide semiconductor field effect transistor (MOSFET) during manufacture process.

2. The power semiconductor device according to claim 1, wherein said characteristic circuit is chosen from the group consisting of a pair of back-to-back or face-to-face series coupling Schotty diodes, a pair of back-to-back or face-to-face series coupling SSDs, a pair of back-to-back or face-to-face series coupling Zener diodes, a pair of back-to-back or face-to-face series coupling Schotty diode and Zener diode, a pair of back-to-back or face-to-face series coupling Schotty diode and SSD, a pair of back-to-back or face-to-face series coupling Zener diode and SSD, a four layer semiconductor device and permutations and combinations thereof, wherein said back-to-back coupling means P-type nodes interconnecting and said face-to-face coupling means N-type nodes interconnecting.

3. The power semiconductor device according to claim 2, wherein said four layer semiconductor device is a piece of DIAC or TRIAC.

4. The power semiconductor device according to claim 1, wherein said characteristic circuit comprising a P-type node and an N-type node that coupling respectively to said drain node and said source node of said MOSFET.

5. The power semiconductor device according to claim 4 wherein said characteristic circuit is one fast diode, one Schotty diode, one Zener diode or permutations and combinations thereof.

6. A power semiconductor device for synchronous rectification wherein at least one characteristic circuit is coupling externally between a drain node and a source node of a metal oxide semiconductor field effect transistor (MOSFET).

7. The power semiconductor device according to claim 6 wherein said characteristic circuit is chosen from the group consisting of a pair of back-to-back or face-to-face series coupling Schotty diodes, a pair of back-to-back or face-to-face series coupling SSDs, a pair of back-to-back or face-to-face series coupling Zener diodes, a pair of back-to-back or face-to-face series coupling Schotty diode and Zener diode, a pair of back-to-back or face-to-face series coupling Schotty diode and SSD, a pair of back-to-back or face-to-face series coupling Zener diode and SSD, a four layer semiconductor device and permutations and combinations thereof, wherein said back-to-back coupling means P-type nodes interconnecting and said face-to-face coupling means N-type nodes interconnecting.

8. The power semiconductor device according to claim 7, wherein said four layer semiconductor device is a piece of DIAC or TRIAC.

9. The power semiconductor device according to claim 6, wherein said characteristic circuit comprising a P-type node and an N-type node that coupling respectively to said drain node and said source node of said MOSFET.

10. The power semiconductor device according to claim 9, wherein said characteristic circuit is one fast diode, one Schotty diode, one Zener diode or permutation and combination thereof.

11. A synchronous rectifier circuit for rectifying a power source, comprising:
a primary winding for receiving said power source;
a first secondary winding coupling to at least one power semiconductor device as in any preceding claims; and
a second secondary winding coupling to said power semiconductor device for providing said power semiconductor device operation voltage; wherein:
said power semiconductor device synchronously rectifying said power source and thus an output voltage is obtained.

12. The synchronous rectifier circuit according to claim 11, further comprising:
a sensor circuit sampling said output voltage;
a feedback circuit coupling to said sensor circuit for providing a feedback signal according to sampled output voltage of said sensor circuit; and
a control circuit coupling to said feedback circuit for adjusting said output voltage to a predetermined value according to said feedback signal.

13. The synchronous rectifier circuit according to claim 12 wherein said control circuit is a PWM controller or a PFM controller.

14. The synchronous rectifier circuit according to claim 12 wherein said sensor circuit is a voltage dividing circuit.

15. The synchronous rectifier circuit according to claim 12 wherein said feedback circuit further comprising:
an adjustable precision shunt regulator integrated circuit coupling to said sensor circuit for receiving sampled output voltage from said sensor circuit; and
a photo coupler being controlled by said adjustable precision shunt regulator integrated circuit and coupling to said control circuit.

16. The synchronous rectifier circuit according to claim 15 wherein while said output voltage getting higher than a predetermined voltage, said adjustable precision shunt regulator integrated circuit activates and conducts the collector and the emitter of the output side of said photo coupler such that said feedback signal being transferred to said control circuit and lowering said output voltage; while said output voltage getting lower, said adjustable precision shunt regulator integrated circuit deactivates such raising said output voltage.

17. The synchronous rectifier circuit according to claim 11, further comprising a filter circuit for said output voltage.

18. The synchronous rectifier circuit according to claim 17 wherein said filter circuit is a π-type filter.

19. The synchronous rectifier circuit according to claim 11 wherein said synchronous rectifier circuit is capable of half-wave synchronous rectification.

20. The synchronous rectifier circuit according to claim 11 wherein said synchronous rectifier circuit is capable of full-wave synchronous rectification.
